(19) United States
(12) Patent Application Publication
(10) Pub. No.: US 2025/0304767 A1
(43) Pub. Date: Oct. 2, 2025

(54) CREEP-RESISTANT POLYESTER COMPOSITIONS

(71) Applicant: ENVALIOR DEUTSCHLAND GMBH, Düsseldorf (DE)

(72) Inventors: Jochen ENDTNER, Düsseldorf (DE); Matthias BIENMÜLLER, Düsseldorf (DE)

(21) Appl. No.: 18/864,205

(22) PCT Filed: Nov. 7, 2022
(86) PCT No.: PCT/EP2022/081004

§ 371 Date: Nov. 8, 2024

(30) Foreign Application Priority Data
May 12, 2022 (EP) 22172926.2

(51) Int. Cl. C08K 5/5317; C08J 3/20; C08K 5/5313; C08K 7/14

(52) U.S. Cl. CPC C08K 5/5317; C08J 3/203; C08K 5/5313; C08K 7/14; C08J 2367/02

(57) ABSTRACT

The invention relates to the use of an aluminium salt of the organic phosphorus compound according to formula (I), (I), to achieve a CTI A of 600 according to IEC 60112-2010 in or in polyester based products, as well as flame retardant and creep resistant polyester based compositions and to articles to be made therefrom based on at least one polyester comprising at least one aluminium salt of the organic phosphorus compound of the general formula (I) and to at least one organic phosphinic acid salt and/or at least one diphosphinic acid salt, and to a process for the preparation thereof.

The present invention relates to the use of an aluminum salt of the organic phosphorus compound of formula (I)

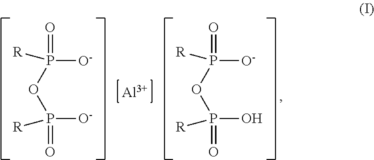

to achieve a CTI A of 600 according to IEC 60112-2010 in or for polyester-based products and to flame-retarded and tracking-resistant polyester-based compositions and products producible therefrom based on at least one polyester comprising at least one aluminum salt of the organic phosphorus compound of general formula (I) and at least one organic phosphinic acid salt and/or at least one diphosphinic acid salt and to a process for production thereof.

### BACKGROUND

Polyesters, preferably polyalkylene terephthalates or polycycloalkylene terephthalates and in particular polybutylene terephthalate (PBT), are important materials for example for use in motor vehicles, in components for the electricals and electronics industry or in household appliances on account of their good mechanical stability, their low water absorption and their good processability. Of particular note are especially also the exceptional electrical insulation properties which, unlike in polyamides for example, are largely retained even at elevated usage temperatures and in the presence of moisture, as is particularly relevant for applications in fast-charging electric vehicles. In applications of the polyesters in proximity to current-conducting parts, flame-retarded materials are often employed in order thus to counter the risk of fire caused by overheated wires or contacts. Good self-extinguishing characteristics, in particular a UL94 V-0 classification according to Underwriters Laboratories Inc. Standard of Safety, “Test for Flammability of Plastic Materials for Parts in Devices and Appliances”, p. 14 to p. 18 Northbrook 1998, are especially demanded.

In addition to today's ever increasing demand for the use of halogen-free flame retardants for environmental reasons, sought after characteristics in industrial applications include high impact toughness coupled with strength and stiffness, a relatively low density and a relatively high tracking resistance according to IEC60112-2010 in polyester-based products.

The desire for maximum design freedom and thus higher complexity of component geometry in conjunction with a cost-driven need for automation-friendly and readily integrable mass production processes ideally also demands materials that may be joined to one another by laser transmission welding [https://de.wikipedia.org/wiki/Laserdurchstrahlschwei%C3%9Fen]. For a laser-transparent joining partner this requires a high laser transmittance at the laser wavelength to be employed. The latter is a great challenge particularly for products based on flame-retarded polyesters, since flame retardants in particular scatter or even absorb the laser light, as is the case for example for a number of nitrogen-containing flame retardant synergists but also in particular for antimony trioxide as is commonly used as a synergist in halogen-containing flame retardants.

### PRIOR ART

In table 4, WO 2021/076169 A1 discloses polymer compositions comprising polybutylene terephthalate, glass, aluminum methylphosphonate and melam.

In example 4, DE 10 2017 215776 A1 teaches a composition comprising 50% by weight of polybutylene terephthalate, 30% by weight of glass fibers and 20% by weight of a flame retardant combination FM 4 composed of the aluminum salt of diethylphosphinic acid comprising 10 mol % of aluminum ethylbutylphosphinate and 5 mol % of aluminum ethylphosphonate produced by the process according to U.S. Pat. No. 7,420,007 B2.

WO 2012/139990 A1 discloses tracking-resistant, flame-retardant, reinforced thermoplastic molding materials based on polyalkylene terephthalates which in addition to a flame retardant composed of nitrogen-containing or phosphorus-containing compounds also comprise a polyolefin from the group of polyethylene, polypropylene and polypropylene copolymers. While these feature elevated tracking resistances, the use of polyolefins as an additional polymer risks downgrading the advantages typical for polyalkylene terephthalates, in particular a high surface tension and a high color stability under thermal stress, especially since the use of polyolefins—in particular polyethylene—in polyalkylene terephthalate formulations also brings about an increased risk of residues in the injection mold.

EP 3 067 388 A1 discloses flame-retarded polyester-based molding materials comprising aluminum tris(diethyl phosphinate) and melamine cyanurate, where addition of barium sulfate achieved an improvement in tracking resistance. However, the addition of solids not meltable under injection molding conditions, such as barium sulfate, leads to a deterioration in mechanical properties and also a reduction in laser transmittance such as is unwanted especially in laser-transmission-weldable applications. Furthermore, in the case of PBT, EP 3 067 388 A1 was only able to achieve a V-1 classification according to UL 94.

Starting from the prior art it is an object of the present invention to provide flame-retarded, tracking-resistant and glass fiber-reinforced polyester-based thermoplastic molding materials without the use of polyolefins and barium sulfate and preferably without the use of nitrogen-containing, in particular melamine-based, synergists to achieve good mechanical properties while achieving a V-0 classification according to UL94 at wall thicknesses of not more than 0.8 mm. According to the invention elevated tracking resistance is to be understood as meaning achieving a CTI A of 600 according to IEC 60112-2010. This improved tracking resistance shall ideally not result in adverse effects on laser transmittance and thus not impede or render impossible the use in laser transmission welding. Good mechanical properties in the context of the present invention are especially signified by high values in IZOD impact strengths determinable according to DIN EN ISO 180.

It has now been found that, surprisingly, the phosphorus-containing aluminum salts of general formula (I)

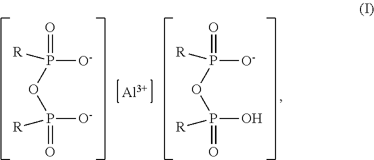

wherein R represents C₁-C₁₂-alkyl, achieve a CTI A of 600 according to IEC 60112-2010 in polyester-based products and in conjunction with at least one organic metal phosphinate or diphosphinic acid salt in reinforced polyester-based compositions and products producible therefrom achieve the complex object of the invention in respect of flame retardancy, mechanical properties and especially also laser transparency when the mass fraction of the aluminum salt of general formula (I) is less than the mass fraction of employable organic metal phosphinate or diphosphinic acid salt.

It has surprisingly also been found that the phosphorus-containing aluminum salts of general formula (I) made it possible in a departure from the standard IEC 60112-2010 to carry out testing not with 50 droplets in each case on 5 test specimens (250 droplets) but rather, and even more demandingly, with 100 droplets in each case on 3 test specimens (altogether 300 droplets), the average number of droplets until failure of the material due to a tracking current of >0.5 A or ignition with a subsequent continuous flame on the polyester-based test specimen being markedly higher than in the comparative examples without the phosphorus-containing aluminum salts of general formula (I).

### IZOD Impact Strength

The IZOD impact strength according to DIN EN ISO 180 used in the context of the present invention to obtain mechanical parameters may be used not only for rigid thermoplastic injection molding and extrusion molding materials, thermosetting materials and thermotropic liquid crystal polymers but also for filled and reinforced materials. The impact energy absorbed during fracture E_{C} of an unnotched test specimen is related to the initial cross-sectional area of the test specimen according to the following equation:

$${a}_{iU} = \frac{{E}_{c}}{h \cdot b}$$

where a_{Iu}=impact strength, h=thickness and b=width.

The test specimens employable here may be produced according to the corresponding molding material standard or by pressing and injection molding or be taken from multipurpose test specimens (DIN EN ISO 527 [2]). The dimensions of the unnotched test specimen employed in the context of the present invention according to DIN EN ISO 3167, type A are: length l=(80±2) mm; width b=(10.0±0.2) mm; thickness h=(4.0±0.2) mm. https://wiki.polymerservice-merseburg.de/index.php/Schlagbiegeversuch

### Laser Transmittance

According to the invention a high laser transmittance is to be understood as meaning a transmittance of at least 8%, preferably at least 9%, measured on plates having a thickness of 1.5 mm with an LPKF TMG3 transmittance measuring instrument from LPKF Laser & Electronics AG, Garbsen, Germany at a laser wavelength of 980 nm. The transmittance measuring instrument LPKF TMG3 is a certified, traceably calibrated measuring instrument. Its performance was demonstrated in the context of a statistical measurement system analysis (MSA). The instrument further corresponds to the specifications of the automotive standard IATF 16949 and is thus directly qualified for standard-compliant quality assurance. The measurements in the context of the present invention are carried out on the basis of DVS Guideline 2243 (January 2014) “Laserstrahlschweißen thermoplastischer Kunststoffe” using test specimens having dimensions of 125 mm×13 mm×1.5 mm in the near infrared (NIR) range. Before measurement the transmittance measuring instrument LPKF TMG3 from LPKF Laser & Electronics AG is calibrated with a measurement standard produced according to DIN EN ISO/IEC 17025. In the context of the present invention the measurements are carried out at a laser wavelength of 980 nm.

### Tracking Resistance

According to https://de.wikipedia.org/wiki/Kriechstromfestigkeit tracking resistance describes the insulation strength of the surface (tracking path) of insulating materials, in particular upon exposure to moisture and contaminants. It defines the maximum tracking current that may occur under standardized test conditions (predetermined voltage, conductive layer material) in a defined test configuration (electrode distance, electrode shape). Tracking resistance is reported with the CTI value (Comparative Tracking Index). The CTI value indicates the voltage in volts (V) up to which the material under investigation shows no tracking when 50 droplets of standardized electrolyte solutions (A or B, accordingly KA or KB value) are applied. Measurement is carried out at the surface and a droplet falls between two platinum electrodes every 30+/−5 seconds. The failure criterion is a tracking current of >0.5 A or ignition of the component. Details regarding the method of measurement of the CTI value are specified in IEC 60112.

Polyester-based compositions according to the invention shall finally also exhibit a V-0 classification having regard to the UL94 V-0 classification specified in WO 2021/076169 A1 at a maximum thickness of 0.8 mm determinable according to the method UL94V (Underwriters Laboratories Inc. Standard of Safety, “Test for Flammability of Plastic Materials for Parts in Devices and Appliances”, p 14-18 Northbrook 1998) or at least show no substantial decline relative to the prior art.

In the context of the present invention “alkyl” is to be understood as meaning a straight-chain or branched saturated hydrocarbon group. In some embodiments an alkyl group having 1 to 6 carbon atoms is employed. This may be referred to as a “lower alkyl group”. Preferred alkyl groups are methyl (Me), ethyl (Et), propyl, in particular n-propyl and isopropyl, butyl, in particular n-butyl, isobutyl, sec-butyl, tert-butyl and pentyl groups, in particular n-pentyl, isopentyl, neo-pentyl and hexyl groups and the like. The term polyakylene is defined analogously.

For clarity it is noted that the scope of the present invention includes all specified definitions and parameters recited generally or in preferred ranges in any desired combinations. This relates especially to the specified mass fractions in terms of the compositions according to the invention, the uses described according to the invention and the processes described according to the invention. The standards mentioned in the scope of this application refer to the version applicable on the application date of this invention. An aryl group (Ar for short) is an organochemical radical having an aromatic basic structure. Aryl is thus a general description for a monovalent group of atoms deriving from aromatic hydrocarbons by removal of a hydrogen atom bonded to the ring. Most aryl radicals are derived from benzene (C₆H₆) and the simplest aryl group is the phenyl group (Ph), (—C₆H₅). Aryl radicals may either occur as a fragment of a molecule or as an unstable free radical.

### Subject Matter of the Invention

The present invention provides for the use of aluminum salts of general formula (I)

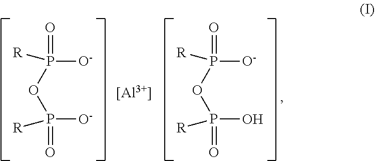

wherein R represents C₁-C₁₂-alky, preferably methyl, ethyl, isopropyl or isobutyl, tert-butyl or n-butyl, particularly preferably ethyl or methyl, very particularly preferably methyl, to achieve a CTI A of 600 according to IEC 60112-2010 in or for polyester-based products, preferably for or in polyalkylene terephthalate- or polycycloalkylene terephthalate-based products, in particular for or in polybutylene terephthalate (PBT)-, polyethylene terephthalate (PET)- or poly-1,4-cyclohexanedimethanol terephthalate-based products. For clarity it is noted that for polybutylene terephthalate (PBT)-, polyethylene terephthalate (PET)- or poly-1,4-cyclohexanedimethanol terephthalate-based products is synonymous with in polybutylene terephthalate (PBT)-, polyethylene terephthalate (PET)- or poly-1,4-cyclohexanedimethanol terephthalate-based products.

First of all the present invention relates to compositions comprising
A) per 100 parts by mass of polyalkylene terephthalate or polycycloalkylene terephthalate,
B) 1 to 80 parts by mass, preferably 2 to 60 parts by mass, particularly preferably 3 to 30 parts by mass, especially preferably 5 to 20 parts by mass, of at least one aluminum salt of general formula (I)

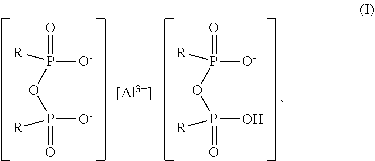

wherein R represents C₁-C₁₂-alkyl, preferably methyl, ethyl, isopropyl or isobutyl, tert-butyl or n-butyl, particularly preferably ethyl or methyl, very particularly preferably methyl,
and
C) 5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof,

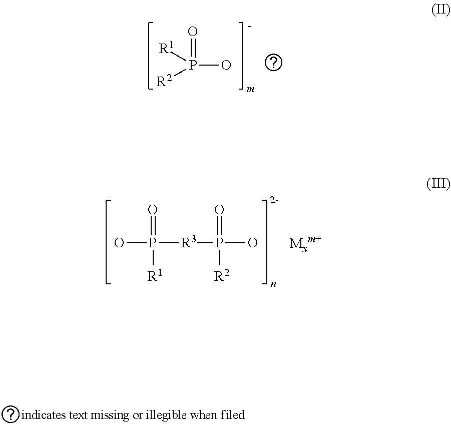

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
M represents aluminum, zinc or titanium,
m represents an integer from 1 to 4,
n represents an integer from 1 to 3,
x represents 1 and 2,
wherein n, x and m in formula (III) can simultaneously assume only integers such that the diphosphinic acid salt of formula (III) is uncharged as a whole and
D) 3 to 300 parts by mass, preferably 5 to 200 parts by mass, particularly preferably 10 to 120 parts by mass, especially preferably 15 to 90 parts by mass, of at least one glass-based filler and/or reinforcer
   with the proviso that component B) is present in lower mass fractions than component C).

The present invention also provides products based on the compositions according to the invention, in particular products for electromobility, for household appliances and in the electronics and electricals sector.

The preparation of polyalkylene terephthalate or polycycloalkene terephthalate-based compositions, in particular PBT-, PET- or poly-1,4-cyclohexanedimethanol terephthalate-based compositions, for use in products in electromobility, in household appliances and in the electronics and electricals sector is carried out by mixing the components A), B), C) and D) employable as starting materials in at least one mixing apparatus in the aforementioned mass fraction ratios. The mixing affords as intermediate products molding materials based on the compositions according to the invention. These molding materials may either consist exclusively of the components A), B), C) and D) or else additionally comprise at least one further component E). In the case where laser-transparent compositions are provided, further components E) are to be selected such that laser-absorbent additives are avoided.

The present invention further provides a process for producing products, preferably products for electromobility, for household appliances and in the electronics and electricals sector, comprising mixing or blending component A) 100 parts by mass of polyalkylene terephthalate or polycycloalkene terephthalate, in particular polybutylene terephthalate, polyethylene terephthalate or poly-1,4-cyclohexanedimethanol terephthalate, with
B) 1 to 80 parts by mass, preferably 2 to 60 parts by mass, particularly preferably 3 to 30 parts by mass, especially preferably 5 to 20 parts by mass, of at least one aluminum salt of general formula (I)

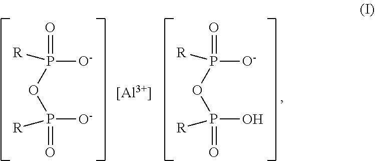

wherein R represents C₁-C₁₂-alkyl, preferably methyl, ethyl, isopropyl or isobutyl, tert-butyl or n-butyl, particularly preferably ethyl or methyl, very particularly preferably methyl,
and
C) 5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof,

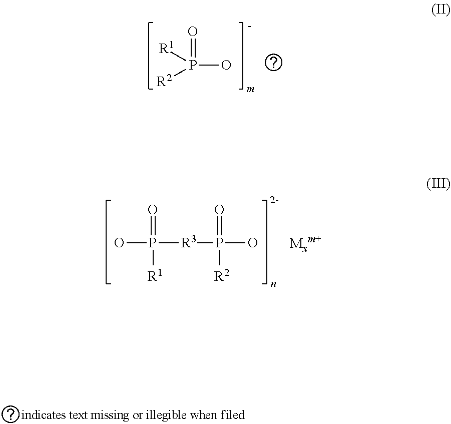

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M represents aluminum, zinc or titanium,
   m represents an integer from 1 to 4,
   n represents an integer from 1 to 3,
   x represents 1 and 2,
wherein n, x and m in formula (III) can simultaneously assume only integers such that the diphosphinic acid salt of formula (III) is uncharged as a whole, with
D) 3 to 300 parts by mass, preferably 5 to 200 parts by mass, particularly preferably 10 to 120 parts by mass, especially preferably 15 to 90 parts by mass, of at least one glass-based filler and/or reinforcer
   and optionally with further additives in at least one mixing apparatus and finally processing the resulting mixture by injection molding with the proviso that component B) is employed in lower mass fractions than component C).

The components are preferably kneaded, compounded, extruded or rolled into a molding material. This mixing is preferably carried out at a temperature in the range from 230° C. to 300° C., particularly preferably by compounding on a corotating twin-screw extruder or Buss kneader. It may be advantageous to premix individual components.

The process of injection molding has the feature that the raw material, preferably in pellet form, is melted (plasticized) in a heated cylindrical cavity and as the injection molding material injected under pressure into a temperature-controlled cavity. After cooling (solidification) of the material, the injection molded part is demolded.

A distinction is made between
1. Plasticizing/melting
2. Injection phase (filling operation)
3. Holding pressure phase (due to thermal contraction during crystallization)
4. Demolding.

An injection molding machine consists of a clamping unit, the injection unit, the drive means, and the controller. The clamping unit includes fixed and movable clamping plates for the mold, an end plate, and tie bars and drive means of the movable mold clamping plate (toggle joint or hydraulic clamping unit).

An injection unit comprises the electrically heatable barrel, the drive means for the screw (motor, transmission) and the hydraulics for displacing the screw and the injection unit. The task of the injection unit is to melt, meter, inject, and exert holding pressure on (due to contraction) the powder/the pellet material. The problem of the backflow of the melt within the screw (leakage flow) is solved by backflow barriers.

In the injection mold the inflowing melt is then detached and cooled in order thus to manufacture the product to be manufactured. Two mold halves are always required for this purpose. A distinction is made between the following functional complexes in injection molding:
runner system
shaping inserts
venting
machine mounting and force absorption
demolding system and transmission of motion
temperature control

The present invention accordingly also relates to products obtainable by injection molding of the compositions according to the invention.

### FURTHER PREFERRED EMBODIMENTS OF THE INVENTION

In a further preferred embodiment the invention further relates to compositions and products based thereupon comprising not only the components A) to D) but also as component E) at least one further additive distinct from components B), C) and D), preferably in an amount of 0.01 to 100 parts by mass, particularly preferably in an amount of 0.05 to 50 parts by mass, very particularly preferably in an amount of 0.1 to 30 parts by mass, in each case based on 100 parts by mass of component A) with the proviso that if retention of laser transparency is required laser-absorbent additives are avoided.

### Component A)

The polyalkylene terephthalates or polycycloalkylene terephthalates employable as component A) according to the invention may be produced by various processes, synthesized from different units and in specific use cases may be made into materials having specifically adjusted combinations of properties alone or in combination with processing aids, stabilizers, polymeric alloying partners (e.g. elastomers) or else reinforcing materials (for example mineral fillers or glass fibers) and optionally further additives. Blends with proportions of other polymers are also suitable, wherein one or more compatibilizers may optionally be employed. The properties of the polymers may be improved by addition of elastomers if required.

Preferred polyalkylene terephthalates or polycycloalkylene terephthalates are producible by known methods from terephthalic acid (or its reactive derivatives) and aliphatic or cycloaliphatic diols having 2 to 10 carbon atoms (Kunststoff-Handbuch, vol. VIII, p. 695-743, Karl Hanser Verlag, Munich 1973).

Preferred polyalkylene terephthalates or polycycloalkylene terephthalates comprise at least 80 mol %, preferably at least 90 mol %, based on the dicarboxylic acid, of terephthalic acid radicals and at least 80 mol %, preferably at least 90 mol %, based on the diol component, of 1,4-cyclohexanedimethanol and/or ethylene glycol and/or propane-1,3-diol (in the case of polypropylene terephthalate) and/or butane-1,4-diol radicals.

Preferred polyalkylene terephthalates or polycycloalkylene terephthalates may include not only terephthalic acid radicals but also up to 20 mol % of radicals of other aromatic dicarboxylic acids having 8 to 14 carbon atoms or radicals of aliphatic dicarboxylic acids having 4 to 12 carbon atoms, in particular radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid.

Preferred polyalkylene terephthalates or polycycloalkylene terephthalates may comprise not only 1,4-cyclohexanedimethanol/ethylene glycol/propane-1,3-diol/butane-1,4-diol but also up to 20 mol % of other aliphatic diols having 3 to 12 carbon atoms or up to 20 mol % of cycloaliphatic diols having 6 to 21 carbon atoms, preferably radicals of propane-1,3-diol, 2-ethylpropane-1,3-diol, neopentyl glycol, pentane-1,5-diol, hexane-1,6-diol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-diol, 2,2-diethylpropane-1,3-diol, hexane-2,5-diol, 1,4-di(ß-hydroxyethoxy)benzene, 2,2-bis(4-hydroxycyclohexyl)propane, 2,4-dihydroxy-1,1,3,3-tetramethylcyclobutane, 2,2-bis(3-ß-hydroxyethoxyphenyl)propane and 2,2-bis(4-hydroxypropoxyphenyl)propane.

Particular preference is given to polyalkylene terephthalates or polycycloalkylene terephthalates produced solely from terephthalic acid and its reactive derivatives, in particular its dialkyl esters, and 1,4-cyclohexanedimethanol and/or ethylene glycol and/or propane-1,3-diol and/or butane-1,4-diol, especially preferably poly-1,4-cyclohexanedimethanol terephthalate, polyethylene terephthalate and polybutylene terephthalate and mixtures thereof.

Preferred polyalkylene terephthalates or polycycloalkylene terephthalates also include copolyesters produced from at least two of the aforementioned acid components and/or from at least two of the aforementioned alcohol components. Particularly preferred copolyesters are poly(ethylene glycol/butane-1,4-diol) terephthalates.

The polyalkylene terephthalates or polycycloalkylene terephthalates generally have an intrinsic viscosity in the range from 30 to 150 cm³/g, preferably in the range from 40 to 130 cm³/g, particularly preferably in the range from 50 to 100 cm³/g in each case measured in phenol/o-dichlorobenzene (1:1 parts by weight) at 25° C. The intrinsic viscosity IV, also known as the Staudinger index or limiting viscosity, is proportional, according to the Mark-Houwink equation, to the average molecular mass and is the extrapolation of the viscosity number VN for the case of vanishing polymer concentrations. It may be estimated from measurement series or through the use of suitable approximation methods (e.g. Billmeyer). The VN [ml/g] is obtained from the measurement of the solution viscosity in the capillary viscometer, for example Ubbelohde viscometer. The solution viscosity is a measure of the average molecular weight of a plastic. The determination is carried out on a dissolved polymer, wherein different solvents (formic acid, m-cresol, tetrachloroethane, phenol, 1,2-dichlorobenzene etc.) and concentrations are employed. The viscosity number VN makes it possible to control the processing and use properties of plastics. A thermal stressing of the polymer, aging processes or the effect of chemicals, weathering and light can be investigated through comparative measurements. The process is standardized for commonly used plastics, in the context of the present invention according to DIN ISO 1628-5 for polyesters. See also: http://de.wikipedia.org/wiki/Viskosimetrie and “http://de.wikipedia.org/wiki/Mark-Houwink-Gleichung”.

The polyalkylene terephthalates or polycycloalkylene terephthalates employable as component A) according to the invention may also be employed in admixture with other polyesters and/or further polymers.

The polyalkylene terephthalates or polycycloalkylene terephthalates employable as component A) may be admixed with customary additives, in particular demolding agents, in the melt during compounding, wherein a person skilled in the art understands “compounding” to mean the plastics-industry term, synonymous with plastics processing, which describes the finishing process for plastics by admixture of additive substances (fillers, additives, etc.) for specific optimization of profiles of properties. The compounding is preferably carried out in extruders, particularly preferably in co-rotating twin-screw extruders, counter-rotating twin-screw extruders, planetary screw extruders or co-compounders, and comprises the process operations of conveying, melting, dispersing, mixing, degassing and pressure buildup.

It is preferable when the polyester employable as component A) is polyalkylene terephthalate or polycycloalkylene terephthalate, particularly preferably polyethylene terephthalate (PET) [CAS No. 25038-59-9] or polybutylene terephthalate [CAS No. 24968-12-5], in particular polybutylene terephthalate (PBT).

Alternatively, the polyester employable as component A) is a polycycloalkylene terephthalate, in particular poly-1,4-cyclohexanedimethanol terephthalate [CAS No. 25037-99-4].

### Component B)

As component B) employable according to the invention it is preferable to employ an aluminum salt of general formula (I),

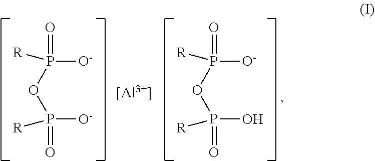

wherein R represents C₁-C₁₂-alkyl, preferably methyl, ethyl, isopropyl or isobutyl, tert-butyl or n-butyl, particularly preferably ethyl or methyl, very particularly preferably methyl.

These aluminum salts of organic phosphorus compounds of general formula (I) employable as component B) may be produced by different processes and synthesized from different units. In the context of the present invention production of the compound (Ia) preferably employable according to the invention where R=methyl utilizes the following process:

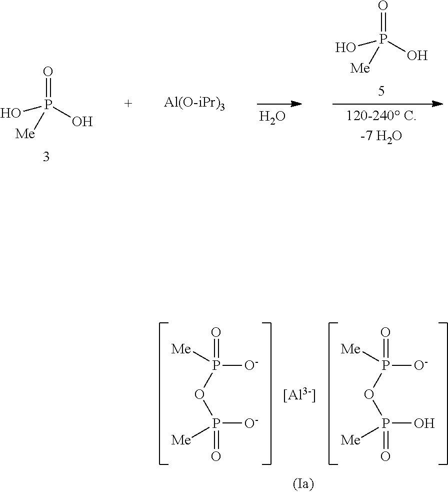

A reaction vessel is charged with 83 g of methyl phosphonic acid and heated to 120° C. An intermediate product produced from 50 g of methylphosphonic acid and 35.4 g of aluminum tris(isopropoxide) is added to the reaction vessel in the presence of water. The resulting solution which contains as intermediate products methylphosphonic acid and aluminum methylphosphonate in a molar ratio of 5:1 is heated to 240° C. with mechanical stirring. The stirring is continued at 240° C. for about 30 minutes until a solid is formed. 500 ml of water are then added and the resulting mixture is stirred for 16 h to form a uniform slurry. The product is finally separated by filtration, washed with 750 ml of water and dried. This results in 64.3 g of the product of formula (Ia) most preferably employable as component B) as fine colorless crystals at a yield of 93%. The empirical formula (Ia) represents repeating monomer units (i.e. coordination units) of a coordination polymer present in crystal form.

Further processes, in particular for R methyl, are derivable from WO 2020/132075 A1, the content of which is hereby incorporated in the present invention in its entirety.

Particular preference is given to component B) according to formula (Ia) with a molar ratio of phosphorus to aluminum determinable by ICP-OES elemental analysis of 4:1, wherein acicular crystals are particularly preferred. See in this regard example 1 in WO 2021/076169 A1. Regarding ICP-OES, see: https://www.itmc.rwth-aachen.de/go/id/gden

### Component C)

As component C) compositions according to the invention comprise at least one phosphinic acid salt of formula (II)

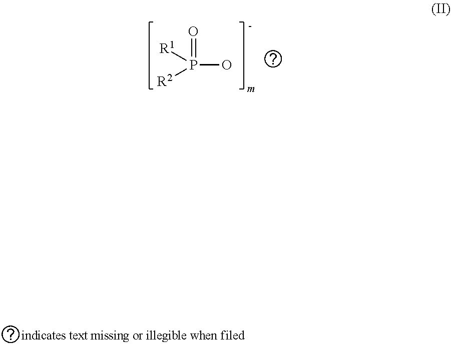

and/or at least one diphosphinic acid salt of formula (III)

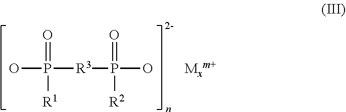

and/or polymers thereof. In the context of the present invention phosphinic acid salts of formula (II) and diphosphinic acid salts of formula (III) are also referred to as phosphinates.

M in formulae (II) or (III) preferably represents aluminum or zinc. It is preferable when R¹, R² in formulae (II) and (III) are identical or different and represent linear or branched C₁-C₆-alkyl and/or phenyl. It is particularly preferable when R¹, R² are identical or different and represent methyl, ethyl, n-propyl, isopropyl, n-butyl, tert-butyl, n-pentyl and/or phenyl.

It is preferable when R³ in formula (III) represents methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene or phenylbutylene. It is particularly preferable when R³ represents phenylene or naphthylene. Suitable phosphinates are described in WO-A 97/39053, the content of which with regard to the phosphinates is hereby incorporated in the present application. Particularly preferred phosphinates in the context of the present invention are aluminum and zinc salts of dimethylphosphinate, of ethylmethylphosphinate, of diethylphosphinate and of methyl-n-propylphosphinate and mixtures thereof.

In formula (II) m preferably represents 2 and 3, particularly preferably 3.

In formula (III) n preferably represents 1 and 3, particularly preferably 3.

In formula (III) x preferably represents 1 and 2, particularly preferably 2.

Very particularly preferably employed as component C) is aluminum tris(diethylphosphinate) [CAS No. 225789-38-8], as obtainable for example from Clariant International Ltd. Muttenz, Switzerland under the trade name Exolit® OP1230 or Exolit® OP1240.

According to the invention component B) is employed in lower mass fractions than component C).

### Component D)

Polymer compositions according to the invention comprise as component D) at least one glass-based filler and/or reinforcer. It is also possible to employ mixtures of two or more different glass-based fillers and/or reinforcers.

Preferably employed as component D) is glass according to DIN1259-1. It is very particularly preferable to employ glass as solid or hollow glass spheres, glass fibers, ground glass or aluminum borosilicate glass having an alkali metal content of 1% (E glass) [CAS No. 65997-17-3].

Having regard to the glass fibers preferably employable according to the invention a person skilled in the art distinguishes according to “http://de.wikipedia.org/wiki/Faser-Kunststoff-Verbund” between chopped fibers, also referred to as short fibers, having a length in the range of 0.1 to 1 mm, long fibers having a length in the range of 1 to 50 mm, and continuous fibers having a length L>50 mm. Short fibers are preferably employed in injection molding and are amenable to direct processing with an extruder. Long fibers are likewise still processible in extruders. Continuous fibers are used as rovings or fabric in fiber-reinforced plastics. Products comprising continuous fibers achieve the highest rigidity and strength values. Furthermore, ground glass fibers are offered, the length of which after grinding is typically in the range of 70 to 200 μm.

Glass fibers particularly preferably employable as component D) according to the invention are chopped long glass fibers having an average starting length in the range from 1 to 50 mm, particularly preferably in the range from 1 to 10 mm, very particularly preferably in the range from 2 to 7 mm, wherein the starting length refers to the length before any processing, in particular in a compounder.

Preferred glass fibers employable as component D) have an average fiber diameter in the range from 7 to 18 μm, particularly preferably in the range from 9 to 15 μm. A possible process for determining the fiber diameter that may be employed is scanning electron microscopy (SEM) (https://de.wikipedia.org/wiki/Rasterelektronenmikroskop).

In a preferred embodiment the glass fibers preferably employable as component D) are treated with a suitable size system or an adhesion promoter/adhesion promoter system. It is preferable to employ a silane-based size system/adhesion promoter. Particularly preferred silane-based adhesion promoters for the treatment of the glass fibers preferably employable as component D) are silane compounds of general formula (IV)

(X—(CH₂)_{q})ₖ—Si—(O—CrH₂ᵣ₊₁)₄₋ₖ (IV)
wherein
X represents NH₂, carboxyl, HO, or

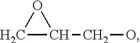

q in formula (IV) represents an integer from 2 to 10, preferably 3 to 4,
r in formula (IV) represents an integer from 1 to 5, preferably 1 to 2, and
k in formula (IV) represents an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane and the corresponding silanes, which comprise as substituent X in formula (IV) a glycidyl group or a carboxyl group, wherein carboxyl groups are especially very particularly preferred.

The treatment of the glass fibers preferably employable as component D) comprises employing the adhesion promoter, preferably the silane compounds of formula (IV), preferably in amounts of 0.05% to 2% by weight, particularly preferably in amounts of 0.25% to 1.5% by weight and very particularly preferably in amounts of 0.5% to 1% by weight, in each case based on 100% by weight of component D).

The glass fibers preferably employable as component D) may be shorter in the composition or product than the originally employed glass fibers as a consequence of the processing to afford the composition or the product. The arithmetic average of the glass fiber length determinable by high-resolution X-ray computer tomography after processing is thus often only in the range from 150 μm to 300 μm.

According to “http://www.r-g.de/wiki/Glasfasern”, glass fibers are produced in the melt spinning method (die drawing, bar drawing, and die blowing methods). In the die drawing method the hot glass composition flows through hundreds of die holes of a platinum spinning plate under the influence of gravity. The elementary threads can be drawn in unlimited length at a speed of 3-4 km/minute.

A person skilled in the art distinguishes between various types of glass fibers, a number of which are listed below for example:
E glass, the most commonly used material having an optimal price/performance ratio (E glass from R&G) and having a composition according to https://www.r-g.de/wiki/Glasfasern of 53-55% SiO₂, 14-15% Al₂O₃, 6-8% B₂O₃, 17-22% CaO, <5% MgO, <1% K₂O/Na₂O and about 1% other oxides;
H glass, hollow glass fibers for reduced weight (R&G hollow glass fiber fabric 160 g/m² and 216 g/m²)
R, S glass, for elevated mechanical demands (S2 glass from R&G)
D glass, borosilicate glass for elevated electrical demands;
C glass, having elevated chemical resistance;
quartz glass, having high temperature resistance.

Further examples may be found at “http://de.wikipedia.org/wiki/Glasfaser”. For plastics reinforcement, E glass fibers have attained the greatest importance. The “E” in E glass stands for electrical glass, since it was originally used especially in the electrical industry.

For the production of E glass, glass melts are produced from pure quartz with additions of limestone, kaolin, and boric acid. They comprise different amounts of various metal oxides in addition to silicon dioxide. The composition determines the properties of the products. It is preferable according to the invention to employ at least one type of glass fibers from the group of E glass, H glass, R,S glass, D glass, C glass and quartz glass, particularly preferably glass fibers made of E glass.

Glass fibers made of E glass are the most widely used reinforcing material. Strength properties correspond to those of metals (for example aluminum alloys) and the specific weight of laminates containing E glass fibers is lower than that of the metals. E glass fibers are noncombustible, heat-resistant up to about 400° C. and resistant to most chemical and weathering influences.

However, it is also preferable as component D) to employ non-fibrous and non-foamed ground glass having a particle size distribution determinable by laser diffractometry according to ISO 13320 with a d90 value in the range from 5 to 250 μm, preferably in the range from 10 to 150 μm, particularly preferably in the range from 15 to 80 μm, very particularly preferably in the range from 16 to 25 μm. Having regard to the d90 values, their determination and their meaning reference is made to Chemie Ingenieur Technik (72) p. 273-276, March 2000, Wiley-VCH Verlags GmbH, Weinheim, 2000 according to which the d90 value is that particle size below which 90% of the particles lie.

Preferred according to the invention is a non-fibrous and unfoamed ground glass of particulate, non-cylindrical shape that has a length-to-thickness ratio determinable by scanning electron microscopy of less than 5, preferably less than 3, particularly preferably less than 2. It goes without saying that this excludes the value zero.

The unfoamed and non-fibrous ground glass employable as component D) in one embodiment is also characterized in that it does not have the glass geometry typical for fibrous glass having a cylindrical or oval cross section with a length-to-diameter ratio (L/D ratio) determinable by scanning electron microscopy of greater than 5.

The unfoamed and non-fibrous ground glass employable according to the invention as component D) in one embodiment is preferably obtained by grinding glass with a mill, preferably a ball mill and particularly preferably with subsequent sifting/sieving. Preferred starting materials for grinding of the non-fibrous and unfoamed ground glass employable as component D) in one embodiment also include glass wastes such as are especially generated in the production of glass products as undesired byproduct and/or as an off-spec product. This especially includes waste glass, recycling glass and broken glass such as may especially be generated in the production of window or bottle glass and in the production of glass-containing fillers and reinforcers, especially in the form of so-called melt cake. The glass may be colored, wherein uncolored glass is preferred for use as a starting material for use in component D).

### Component E)

Employed components E) are preferably selected from at least one further additive distinct from components B), C) and D) with the proviso that if retention of laser transparency is required laser-absorbent additives are avoided. Preferred additives employable as component E) include antioxidants, heat stabilizers, UV stabilizers, gamma ray stabilizers, hydrolysis stabilizers, antistats, emulsifiers, nucleating agents, plasticizers, processing aids, impact modifiers, lubricants and/or demolding agents, flow auxiliaries or elastomer modifiers, chain extending additives, flame retardants distinct from components B) and C) and fillers and reinforcers or colorants distinct from component D). The additives may be employed alone or in admixture/in the form of masterbatches. In the case of laser-transparent products the additives employable as component E) are to be selected such that no laser absorbers such as especially carbon black are employed. Laser-absorbent additives are well known to those skilled in the art.

Heat stabilizers preferably employable as component E) are selected from the group of sulfur-containing stabilizers, in particular sulfides, dialkylthiocarbamates or thiodipropionic acids, also heat stabilizers selected from the group of copper salts, here especially copper(I) iodide, which are preferably employed in combination with potassium iodide and/or sodium hypophosphite NaH₂PO₂, also sterically hindered amines, in particular tetramethylpiperidine derivatives, aromatic secondary amines, in particular diphenylamines, hydroquinones, substituted resorcinols, salicylates, benzotriazoles and benzophenones, also sterically hindered phenols and aliphatically or aromatically substituted phosphites and variously substituted representatives of these groups.

The sterically hindered phenols are preferably those having at least one 3-tert-butyl-4-hydroxy-5-methylphenyl and/or at least one 3,5-di(tert-butyl-4-hydroxyphenyl) unit, wherein 1,6-hexanediol-bis[3-(3,5-di-tert-butyl-4-hydroxyphenyl)propionate][CAS No. 35074-77-2](Irganox® 259 from BASF SE, Ludwigshafen, Germany), pentaerythritol tetrakis[3-(3,5-di-tert-butyl-4-hydroxyphenyl)propionate][CAS No. 6683-19-8](Irganox® 1010 from BASF SE) and 3,9-bis[2-[3-(3-tert-butyl-4-hydroxy-5-methylphenyl)propionyloxy]-1,1-dimethylethyl]-2,4,8,10-tetraoxaspiro[5.5]undecane [CAS No. 90498-90-1](ADK Stab® AO 80) are particularly preferred. ADK Stab® AO 80 is a commercially available product from Adeka-Palmerole SAS, Mulhouse, France.

Preferably employed among the aliphatically or aromatically substituted phosphites are bis(2,4-dicumylphenyl)pentaerythritol diphosphite [CAS No. 154862-43-8] as is commercially available from Dover Chemical Corp., Dover, USA under the trade name Doverphos® S9228 and tetrakis(2,4-di-tert-butylphenyl)-1,1-biphenyl-4,4′-diylbisphosphonite [CAS No. 38613-77-3] which is commercially available for example as Hostanox® P-EPQ from Clariant International Ltd., Muttenz, Switzerland.

The heat stabilizers employable as component E) are preferably employed in amounts of 0.01 to 2 parts by mass, particularly preferably 0.05 to 1 parts by mass, in each case based on 100 parts by mass of component A).

UV stabilizers employable as component E) preferably include substituted resorcinols, salicylates, benzotriazoles and benzophenones and HALS derivatives (hindered amine light stabilizers) comprising at least one 2,2,6,6-tetramethyl-4-piperidyl unit or benzophenones.

The UV stabilizers employable as component E) are preferably employed in amounts of 0.01 to 2 parts by mass, particularly preferably 0.1 to 1 parts by mass, in each case based on 100 parts by mass of component A).

Employed colorants employable as component E) are preferably selected from inorganic pigments, in particular ultramarine blue, bismuth vanadate, iron oxide, titanium dioxide, zinc sulfide, tin titanium zinc oxides [CAS No. 923954-49-8], also organic dyes, preferably phthalocyanines, quinacridones, benzimidazoles, in particular Ni-2-hydroxy-naphthyl-benzimidazole [CAS No. 42844-93-9] and/or pyrimidine-azo-benzimidazole [CAS No. 72102-84-2] and/or Pigment Yellow 192 [CAS No. 56279-27-7] and also perylenes, anthraquinones, in particular C.I. Solvent Yellow 163 [CAS No. 13676-91-0], wherein this list is nonexhaustive and wherein the selection of the colorant is to be carried out particularly taking into account the requirements of the laser transmission/laser absorption behavior.

In a particular embodiment, preferably in the case of a laser-absorbent component, the employed dyes may also include carbon black and/or nigrosin.

Nucleating agents employable as component E) preferably include sodium or calcium phenylphosphinate, aluminum oxide or silicon dioxide and very particularly preferably talc, wherein this list is nonexhaustive.

Employed flow auxiliaries employable as component E) preferably include copolymers of at least one α-olefin with at least one methacrylic ester or acrylic ester of an aliphatic alcohol. Particular preference is given to copolymers where the α-olefin comprises ethene and/or propene units and the methacrylic ester or acrylic ester comprises linear or branched alkyl groups having 6 to 20 carbon atoms as the alcohol component. 2-ethylhexyl acrylate is very particularly preferred. Copolymers suitable as flow auxiliaries are distinguished not only by their composition but also by their low molecular weight. Copolymers suitable for compositions according to the invention are accordingly above all those having an MFI measured at 190° C. and a loading of 2.16 kg of at least 100 g/10 min, preferably of at least 150 g/10 min, particularly preferably of at least 300 g/10 min. The MFI, melt-flow index, is used to characterize the flow of a melt of a thermoplastic and is subject to the standards ISO 1133 or ASTM D 1238. As a flow auxiliary it is especially preferable to employ a copolymer of ethene and 2-ethylhexyl acrylate having an MFI of 550, known as Lotryl® 37EH550.

As chain extending additives and as hydrolysis stabilizers employable as component E) it is preferable to employ di- or polyfunctional branching or chain extending additives comprising at least two branching or chain extending functional groups per molecule. Branching or chain extending additives are preferably low molecular weight oligomeric or polymeric compounds having at least two chain extending functional groups per molecule capable of reacting with alcohol groups and/or amide groups and/or carboxylic acid groups. Chain extending functional groups are preferably isocyanates, carbodiimides, alcohols, epoxides, maleic anhydride, oxazolines, oxazines and oxazolones, wherein epoxides and carbodiimides are particularly preferred.

Especially preferred di- or polyfunctional branching or chain extending additives are diepoxides based on diglycidyl ether (bisphenol and epichlorohydrin), based on amino epoxy resin (aniline and epichlorohydrin), based on diglycidyl ester (cycloaliphatic dicarboxylic acids and epichlorohydrin), individually or in mixtures, and 2,2-bis[p-hydroxyphenyl]propane diglycidyl ether, bis[p-(N-methyl-N-2,3-epoxypropylamino)phenyl]methane and also epoxidized fatty acid esters of glycerol comprising at least two epoxy groups per molecule.

Particularly preferred di- or polyfunctional branching or chain extending additives are glycidyl ethers, very particularly preferably bisphenol A diglycidyl ether [CAS No. 98460-24-3] or epoxidized fatty acid esters of glycerol, very particularly preferably also epoxidized soybean oil [CAS No. 8013-07-8] and/or epoxidized linseed oil [CAS No. 8016-11-3] and especially particularly preferably carbodiimides, wherein polymeric carbodiimides such as for example poly-2,4,6-triisopropyl-1,3-dicarbodiimide and carbodiimides comprising a pentaerythrityl unit, in particular 14,14′,15,15′-tetradehydro-7,7′-spirobi[dibenzo[b,g][1,9,4,6]dioxadiazacyclododecine], [CAS No. 1231148-36-9] are in turn particularly preferred within the class of carbodiimides.

Plasticizers preferably employable as component E) are dioctyl phthalates, dibenzyl phthalates, butyl benzyl phthalates, hydrocarbon oils or N-(n-butyl)benzenesulfonamide.

Preferred elastomer modifiers employable as component E) inter alia comprise one or more graft polymers of
E.1 5% to 95% by weight, preferably 30% to 90% by weight, of at least one vinyl monomer and
E.2 95% to 5% by weight, preferably 70% to 10% by weight, of one or more graft substrates having glass transition temperatures <10° C., preferably <0° C., particularly preferably <−20° C., wherein the weight percentages are based on 100% by weight of elastomer modifier.

The graft substrate E.2 generally has an average particle size d50 value determinable by laser diffractometry according to ISO 13320 of 0.05 to 10 μm, preferably 0.1 to 5 μm, particularly preferably 0.2 to 1 μm.

Monomers according to E.1 are preferably mixtures of
E.1.1 50% to 99% by weight of vinylaromatics and/or ring-substituted vinylaromatics, in particular styrene, α-methylstyrene, p-methylstyrene, p-chlorostyrene and/or (C₁-C₈)-alkyl methacrylates, in particular methyl methacrylate or ethyl methacrylate, and
E.1.2 1% to 50% by weight of vinyl cyanides, preferably unsaturated nitriles, in particular acrylonitrile and methacrylonitrile, and/or (C₁-C₈)-alkyl (meth)acrylates, in particular methyl methacrylate, glycidyl methacrylate, n-butyl acrylate, t-butyl acrylate and/or derivatives, in particular anhydrides and imides of unsaturated carboxylic acids, in particular maleic anhydride or N-phenyl-maleimide, wherein the percentages by weight of E.1.1 and E.1.2 are based on 100% by weight of elastomer modifier.

Preferred monomers E.1.1 are to be selected from at least one of the monomers styrene, α-methylstyrene and methyl methacrylate and preferred monomers E.1.2 are selected from at least one of the monomers acrylonitrile, maleic anhydride, glycidyl methacrylate and methyl methacrylate. Particularly preferred monomers are E.1.1 styrene and E.1.2 acrylonitrile.

Graft substrates E.2 suitable for the graft polymers employable in the elastomer modifiers include, for example, diene rubbers, EPDM rubbers, i.e. those based on ethylene/propylene and optionally diene, and also acrylate, polyurethane, silicone, chloroprene and ethylene/vinyl acetate rubbers. EPDM stands for ethylene-propylene-diene rubber.

Preferred graft substrates E.2 are diene rubbers, in particular based on butadiene, isoprene etc. or mixtures of diene rubbers or copolymers of diene rubbers or mixtures thereof with further copolymerizable monomers, in particular according to E.1.1 und E.1.2, with the proviso that the glass transition temperature of the component E.2 is <10° C., preferably <0° C., particularly preferably <−10° C.

Particularly preferred graft substrates E.2 are ABS polymers (emulsion, bulk and suspension ABS), wherein ABS stands for acrylonitrile-butadiene-styrene, as described for example in DE-A 2 035 390 or in DE-A 2 248 242 or in Ullmann, Enzyklopadie der Technischen Chemie, vol. 19 (1980), p. 277-295. The gel content of the graft substrate E.2 is preferably at least 30% by weight, particularly preferably at least 40% by weight (measured in toluene).

The elastomer modifiers/graft polymers employable as component E) are produced by free-radical polymerization, preferably by emulsion, suspension, solution or bulk polymerization, in particular by emulsion or bulk polymerization.

Particularly suitable graft rubbers also include ABS polymers produced by redox initiation with an initiator system composed of organic hydroperoxide and ascorbic acid according to U.S. Pat. No. 4,937,285.

Since, as is well known, the graft monomers are not necessarily completely grafted onto the graft substrate in the grafting reaction, graft polymers are according to the invention also to be understood as meaning products that result from (co)polymerization of the graft monomers in the presence of the graft substrate and are co-obtained in the workup.

Likewise suitable acrylate rubbers are based on graft substrates E.2 which are preferably polymers of alkyl acrylates, optionally with up to 40% by weight, based on E.2, of other polymerizable, ethylenically unsaturated monomers. Preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, such as chloroethyl acrylate, glycidyl esters, and mixtures of these monomers. Particularly preferred in this context are graft polymers having butyl acrylate as the core and methyl methacrylates as the shell, in particular Paraloid® EXL2300, Dow Corning Corporation, Midland, Michigan, USA.

Crosslinking may be achieved by copolymerizing monomers having more than one polymerizable double bond as an alternative to the ethylenically unsaturated monomers. Preferred crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes; but also triallyl phosphate and diallyl phthalate.

Particularly preferred crosslinking monomers are allyl methacrylate, ethylene glycol dimethacrylate, diallyl phthalate and heterocyclic compounds having at least 3 ethylenically unsaturated groups.

Very particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, in particular 0.05% to 2% by weight, based on the graft substrate E.2.

For cyclic crosslinking monomers having at least 3 ethylenically unsaturated groups it is advantageous to restrict the amount to below 1% by weight of the graft substrate E.2.

Preferred “other” polymerizable, ethylenically unsaturated monomers which, in addition to the acrylic esters, may optionally be used to produce the graft substrate E.2 are acrylonitrile, styrene, α-methylstyrene, acrylamides, vinyl C₁-C₆-alkyl ethers, methyl methacrylate, glycidyl methacrylate, butadiene. Preferred acrylate rubbers as graft substrate E.2 are emulsion polymers having a gel content of at least 60% by weight.

Further preferably suitable graft substrates according to E.2 are silicone rubbers having graft-active sites, as are described in DE-A 3 704 657, DE-A 3 704 655, DE-A 3 631 540 and DE-A 3 631 539.

Preferred graft polymers comprising a silicone proportion are those comprising methyl methacrylate or styrene-acrylonitrile as the shell and a silicone/acrylate graft as the core. A preferred styrene-acrylonitrile employable as the shell is Metablen® SRK200. Methyl methacrylates preferably employable as the shell include Metablen® S2001 or Metablen® S2030 or Metablen® SX-005. Particular preference is given to using Metablen® S2001. The products having the Metablen® trade name are available from Mitsubishi Rayon Co., Ltd., Tokyo, Japan.

Crosslinking may be achieved by copolymerizing monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes; but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, in particular 0.05% to 2% by weight, based on the graft substrate E.2.

For cyclic crosslinking monomers having at least 3 ethylenically unsaturated groups it is advantageous to restrict the amount to below 1% by weight of the graft substrate E.2.

Preferred “other” polymerizable, ethylenically unsaturated monomers which, in addition to the acrylic esters, may optionally be used to produce the graft substrate E.2 are acrylonitrile, styrene, α-methylstyrene, acrylamides, vinyl C₁-C₆-alkyl ethers, methyl methacrylate, glycidyl methacrylate, butadiene. Preferred acrylate rubbers as graft substrate E.2 are emulsion polymers having a gel content of at least 60% by weight.

Other materials that can likewise be used, alongside elastomer modifiers based on graft polymers, are elastomer modifiers which are not based on graft polymers and have glass transition temperatures <10° C., preferably <0° C., particularly preferably <−20° C. These preferably include elastomers having a block copolymer structure and in addition thermoplastically meltable elastomers, especially EPM, EPDM and/or SEBS rubbers (EPM=ethylene-propylene copolymer, EPDM=ethylene-propylene-diene rubber and SEBS=styrene-ethene-butene-styrene copolymer).

Lubricants and demolding agents employable as component E) are preferably selected from the group of long-chain fatty acids, salts of long-chain fatty acids, ester derivatives of long-chain fatty acids and montan waxes.

Preferred long-chain fatty acids are stearic acid or behenic acid. Preferred salts of the long-chain fatty acids are Ca, Mg, Al or Zn stearate. Preferred ester derivatives of long-chain fatty acids are those based on pentaerythritol, in particular C₁₆-C₁₈ fatty acid esters of pentaerythritol [CAS No. 68604-44-4] or [CAS No. 85116-93-4].

Montan waxes in the context of the present invention are mixtures of straight-chain saturated carboxylic acids having chain lengths of 28 to 32 carbon atoms. It is particularly preferable in accordance with the invention to employ lubricants and/or demolding agents from the group of esters of saturated or unsaturated aliphatic carboxylic acids having 8 to 40 carbon atoms with aliphatic saturated alcohols having 2 to 40 carbon atoms and metal salts of saturated or unsaturated aliphatic carboxylic acids having 8 to 40 carbon atoms, wherein pentaerythritol tetrastearate, calcium stearate [CAS No. 1592-23-0] and/or ethylene glycol dimontanate, here especially Licowax® E [CAS No. 74388-22-0] from Clariant, Muttenz, Basle are very particularly preferred and pentaerythritol tetrastearate [CAS No. 115-83-3] obtainable for example as Loxiol® P861 from Emery Oleochemicals GmbH, Dusseldorf, Germany, is especially particularly preferred.

Further flame retardants preferably employable as component E) are mineral flame retardants, nitrogen-containing flame retardants or phosphorus-containing flame retardants distinct from components B) and C).

In an alternative embodiment—if required and taking into account the disadvantages of the loss of laser transparency—it is also possible to employ flame retardants which, as laser absorbers, have an adverse effect on the laser transmittance of a product based on polymer compositions according to the invention.

Among the mineral flame retardants magnesium hydroxide is particularly preferred.

In an alternative embodiment it is, however, also possible—if required—to employ as flame retardants of component E) nitrogen-containing flame retardants and flame retardant synergists. Preferred nitrogen-containing flame retardants employable as component E) are the reaction products of trichlorotriazine, piperazine, and morpholine according to CAS No. 1078142-02-5, in particular MCA PPM Triazin HF from MCA Technologies GmbH, Biel-Benken, Switzerland, and also melamine cyanurate or condensation products of melamine, in particular melem, melam, melon or higher-condensed compounds of this type. Preferred inorganic nitrogen-containing compounds are ammonium salts.

It is further also possible to employ salts of aliphatic and aromatic sulfonic acids and mineral flame retardant additives, in particular aluminum hydroxide or Ca Mg carbonate hydrates (DE-A 4 236 122) as flame retardants employable for component E).

Also suitable for use as flame retardants of component E) are flame retardant synergists from the group of oxygen-, nitrogen- or sulfur-containing metal compounds. Preference is given to zinc-free compounds, in particular molybdenum oxide, magnesium oxide, magnesium carbonate, calcium carbonate, calcium oxide, titanium nitride, magnesium nitride, calcium phosphate, calcium borate, magnesium borate or mixtures thereof, wherein calcium carbonate is very particularly preferred. Preferably employable calcium carbonate has an average particle size (d50) determinable by laser diffractometry according to ISO 13320 in the range from 0.5 μm to 10 μm, wherein a d50 in the range from 0.7 μm to 5 μm is preferred and a d50 in the range from 1.0 μm to 3 μm is particularly preferred. A suitable measuring instrument for determining the d50 of calcium carbonate is for example a Mastersizer® 2000 from Malvern Panalytical GmbH, Kassel, Germany.

In an alternative embodiment it is, however, also possible—if required—to employ zinc-containing compounds as flame retardants of component E). These preferably include zinc oxide, zinc borate, zinc stannate, zinc hydroxy stannate, zinc sulfide, and zinc nitride, or the mixtures thereof.

In an alternative embodiment it is, however, also possible—if required—to employ calcium stannate or calcium hydroxystannate as flame retardants of component E).

However, employed flame retardants distinct from components B) and C) employable as component E) preferably also include inorganic aluminum salts of phosphonic acid. Phosphonic acid is to be understood as meaning the substance of empirical formula H₃PO₃ [CAS No. 13598-36-2] as per Wikipedia (http://de.wikipedia.org/wiki/Phosphons%C3%A4ure). The salts of phosphonic acid are known as phosphonates. Phosphonic acid may exist in two tautomeric forms, one of them having a free electron pair on the phosphorus atom and the other a double-bonded oxygen to the phosphorus (P═O). The tautomeric equilibrium is entirely on the side of the form having the double-bonded oxygen. According to A. F. Holleman, E. Wiberg: Lehrbuch der Anorganischen Chemie. 101st edition Walter de Gruyter, Berlin/New York 1995, ISBN 3-11-012641-9, p. 764 the terms “phosphorous acid” and “phosphites” should be used only for the tautomeric species having a free electron pair on the phosphorus. However, the terms “phosphorous acid” and “phosphites” were also formerly used for the tautomeric forms having oxygen double-bonded to the phosphorus, and so, in the present invention, the terms “phosphonic acid” and “phosphorous acid” and the terms “phosphonates” and “phosphites” are used synonymously with one another.

Preferred aluminum salts of phosphonic acid are one or more selected from the group of
primary aluminum phosphonate [Al(H₂PO₃)₃],
basic aluminum phosphonate [Al(OH)H₂PO₃)₂·2H₂O],
Al₂(HPO₃)₃·x Al₂O₃·n H₂O where x is in the range from 2.27 to 1 and n is in the range from 0 to 4,
Al₂(HPO₃)₃·(H₂O)_{q} of formula (V) wherein q is 0, 1, 2, 3 or 4, in particular aluminum phosphonate tetrahydrate [Al₂(HPO₃)₃·4H₂O] or secondary aluminum phosphonate [Al₂(HPO₃)₃],
Al₂M_{z}(HPO₃)_{y}(OH)ᵥ·(H₂O), of formula (VI), wherein M represents alkali metal ion(s) and z is in the range from 0.01 to 1.5, y is in the range from 2.63-3.5, v is in the range from 0 to 2 and w is in the range from 0 to 4 and
Al₂(HPO₃)ᵤ(H₂PO₃)ₜ·(H₂O)ₛ of formula (VII), wherein u is in the range from 2 to 2.99, t is in the range from 2 to 0.01 and s is in the range from 0 to 4,
wherein in formula (VI) z, y, and v and in formula (VII) u and t can only assume numbers such that the corresponding aluminum salt of the phosphonic acid is uncharged as a whole.

Preferred alkali metals M in formula (VI) are sodium and potassium.

Particularly preferred aluminum salts of phosphonic acid are selected from the group of
primary aluminum phosphonate [Al(H₂PO₃)₃],
secondary aluminum phosphonate [Al₂(HPO₃)₃],
basic aluminum phosphonate [Al(OH)H₂PO₃)₂·2H₂O],
aluminum phosphonate tetrahydrate [Al₂(HPO₃)₃·4H₂O] and
Al₂(HPO₃)₃·x Al₂O₃·n H₂O where x is in the range from 2.27 to 1 and n is in the range from 0 to 4.

Secondary aluminum phosphonate [Al₂(HPO₃)₃], CAS No. 71449-76-8] and secondary aluminum phosphonate tetrahydrate [Al₂(HPO₃)₃·4H₂O], CAS No. 156024-71-4] are very particularly preferred and secondary aluminum phosphonate [Al₂(HPO₃)₃] is especially preferred.

Preferred further phosphorus-containing flame retardants distinct from components B) and C) further include further organic metal phosphinates, red phosphorus, inorganic metal hypophosphites, further metal phosphonates, derivatives of 9,10-dihydro-9-oxa-10-phosphaphenanthrene-10-oxides (DOPO derivatives), resorcinol bis(diphenylphosphate) (RDP) including oligomers, bisphenol A bis(diphenylphosphate) (BDP) including oligomers, melamine pyrophosphate, melamine polyphosphate, melamine poly(aluminum phosphate), melamine poly(zinc phosphate) or phenoxyphosphazene oligomers and mixtures thereof.

Further flame retardants employable as component E) are char formers, particularly preferably phenol-formaldehyde resins, polycarbonates, polyimides, polysulfones, polyether sulfones or polyether ketones, and anti-drip agents, especially tetrafluoroethylene polymers.

The flame retardants employable as component E) may be added in pure form and via masterbatches or compactates.

In an alternative embodiment—if required and taking into account the disadvantages inter alia of the loss of the halogen-free nature of the flame retardants—it is however also possible to employ halogen-containing flame retardants. Preferred halogen-containing flame retardants are commercially available organic halogen compounds, particularly preferably ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ethers, which can be used alone or in combination with synergists, especially—if the particular use requires it having regard to disadvantages for laser transmittance—antimony trioxide or antimony pentoxide, wherein among halogen-containing flame retardants tetrabromobisphenol A epoxy oligomer and tetrabromobisphenol A oligocarbonate are particularly preferred.

In an alternative embodiment—if the particular use requires it and optionally taking into account the disadvantages for laser transmittance—it is also possible to employ further fillers and reinforcers distinct from component D).

These are preferably selected from one or more fillers and/or reinforces from the group of carbon fibers [CAS No. 7440-44-0], calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No. 1317-65-3], kyanite [CAS No. 1302-76-7], powdered or ground quartz [CAS No. 14808-60-7], mica [CAS No. 1318-94-1], phlogopite [CAS No. 12251-00-2], feldspar [CAS No. 68476-25-5], wollastonite [CAS No. 13983-17-0], montmorillonite [CAS No. 67479-91-8], pseudoboehmite of formula AIO(OH), magnesium carbonate [CAS No. 12125-28-9] and talc [CAS No. 14807-96-6] and—if required—also barium sulfate [CAS No. 7727-43-7].

Wollastonite is particularly preferred among the fibrous fillers or reinforcers distinct from component D). In the case of a laser-absorbent component/product carbon fibers may also be employed as a reinforcing material.

In the case of a laser-absorbent component it is possible to employ as component E), with loss of the property of high laser transmittance, at least one laser absorber selected from the group of antimony trioxide, tin oxide, tin orthophosphate, barium titanate, aluminum oxide, copper hydroxyphosphate, copper orthophosphate, potassium copper diphosphate, copper hydroxide, antimony tin oxide, bismuth trioxide and anthraquinone. Tin oxide, antimony trioxide or antimony tin oxide are particularly preferred. Antimony trioxide is very particularly preferred.

The laser absorber, especially the antimony trioxide, may be employed directly as powder or in the form of masterbatches. Preferred masterbatches are those based on polyamide and/or polyolefins, preferably polyethylene. Antimony trioxide is very particularly preferably employed in the form of a polyamide 6-based masterbatch.

The laser absorber may be employed individually or as a mixture of two or more laser absorbers.

Laser absorbers can absorb laser light of a particular wavelength. In practice, this wavelength is in the range from 157 nm to 10.6 μm. Examples of lasers of these wavelengths are described in WO2009/003976 A1. It is preferable to employ Nd:YAG lasers, which can achieve wavelengths of 1064, 532, 355 and 266 nm, and CO₂ lasers.

### Further Preferred Uses

The present invention preferably relates to the use of
B) aluminum salts of general formula (I)

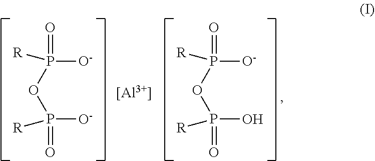

wherein R represents C₁-C₁₂-alkyl, preferably methyl, ethyl, isopropyl or isobutyl, tert-butyl or n-butyl, particularly preferably ethyl or methyl, very particularly preferably methyl, to achieve a CTI A of 600 according to IEC 60112-2010 in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (I) are employed per 100 parts by mass of polyalkylene terephthalate or polycycloalkylene terephthalate, in particular polybutylene terephthalate, polyethylene terephthalate or poly-1,4-cyclohexanedimethanol terephthalate, employable as component A).

The present invention particularly preferably relates to the use of B) aluminum methylphosphonate of formula (Ia)

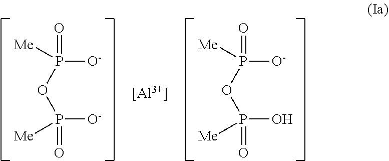

to achieve a CTI A of 600 according to IEC 60112-2010 in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (Ia) are employed per 100 parts by mass of polyalkylene terephthalate or polycycloalkylene terephthalate, in particular polybutylene terephthalate, polyethylene terephthalate or poly-1,4-cyclohexanedimethanol terephthalate, employable as component A).

The present invention preferably relates to the use of B) aluminum salts of general formula (I)

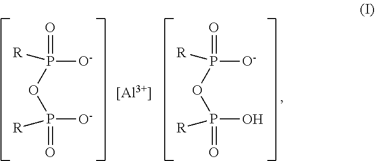

wherein R represents C₁-C₁₂-alkyl, preferably methyl, ethyl, isopropyl or isobutyl, tert-butyl or n-butyl, particularly preferably ethyl or methyl, very particularly preferably methyl, to achieve a CTI A of 600 according to IEC 60112-2010 in polyester-based products, wherein 1 to 80 parts by mass, preferably 2 to 60 parts by mass, particularly preferably 3 to 30 parts by mass, especially preferably 5 to 20 parts by mass, of aluminum salt of formula (I) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
and
5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof employable as component C),

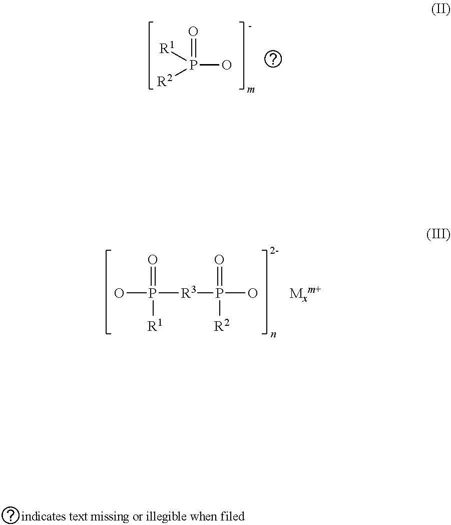

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M represents aluminum, zinc or titanium,
   m represents an integer from 1 to 4,
   n represents an integer from 1 to 3,
   x represents 1 and 2,
wherein n, x and m in formula (III) can simultaneously assume only integers such that the diphosphinic acid salt of formula (III) is uncharged as a whole, with the proviso that component B) is employed in lower mass fractions than component C).

The present invention particularly preferably relates to the use of
B) aluminum methylphosphonate of formula (Ia)

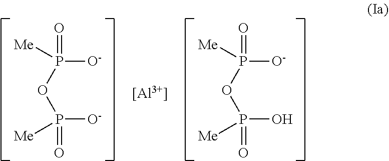

to achieve a CTI A of 600 according to IEC 60112-2010 in or for polyester-based products, wherein 1 to 800 parts by mass, preferably 2 to 60 parts by mass, particularly preferably 3 to 30 parts by mass, especially preferably 5 to 20 parts by mass, of aluminum salt of formula (Ia) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
and
5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof employable as component C),

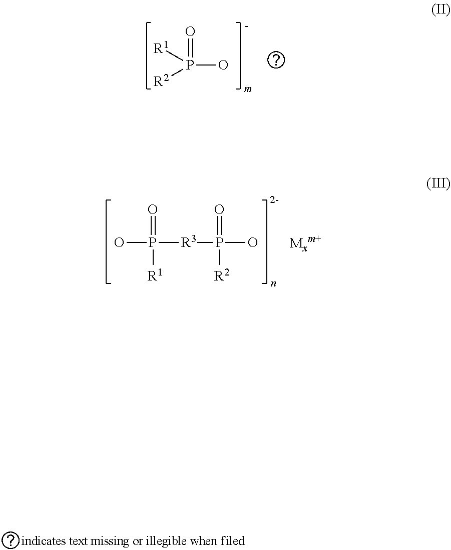

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M represents aluminum, zinc or titanium,
   m represents an integer from 1 to 4,
   n represents an integer from 1 to 3,
   x represents 1 and 2,
wherein n, x and m in formula (III) can simultaneously assume only integers such that the diphosphinic acid salt of formula (III) is uncharged as a whole, with the proviso that component B) is employed in lower mass fractions than component C).

The present invention particularly preferably relates to the use of
B) aluminum methylphosphonate of formula (Ia)

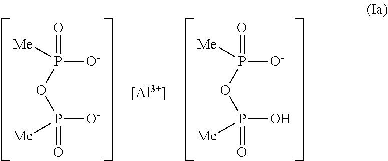

to achieve a CTI A of 600 according to IEC 60112-2010 in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (Ia) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
and
5 to 120 parts by mass, preferably 7 to 80 parts by mass, particularly preferably 8 to 60 parts by mass, especially preferably 10 to 50 parts by mass, of aluminum tris(diethylphosphinate), with the proviso that component B) is employed in lower mass fractions than component C).

The present invention preferably relates to the use of
B) aluminum salts of general formula (I)

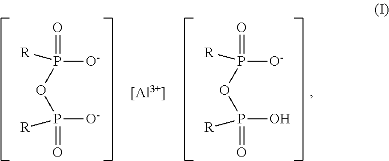

wherein R represents C₁-C₁₂-alkyl, preferably methyl, ethyl, isopropyl or isobutyl, tert-butyl or n-butyl, particularly preferably ethyl or methyl, very particularly preferably methyl, to achieve a CTI A of 600 according to IEC 60112-2010 in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (I) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A)
and
5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof employable as component C),

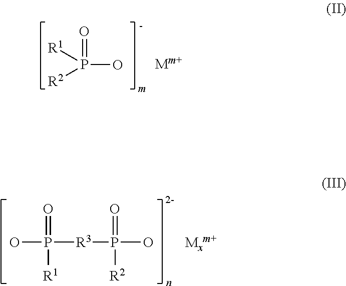

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M represents aluminum, zinc or titanium,
   m represents an integer from 1 to 4,
   n represents an integer from 1 to 3,
   x represents 1 and 2,
wherein n, x and m in formula (III) can simultaneously assume only integers such that the diphosphinic acid salt of formula (III) is uncharged as a whole,
and
3 to 300 parts by mass, preferably 5 to 200 parts by mass, particularly preferably 10 to 120 parts by mass, especially preferably 15 to 90 parts by mass, of at least one glass-based filler and/or reinforcer employable as component D), with the proviso that component B) is employed in lower mass fractions than component C).

The present invention particularly preferably relates to the use of
B) aluminum methylphosphonate of formula (Ia)

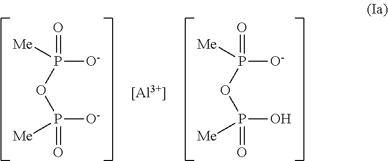

to achieve a CTI A of 600 according to IEC 60112-2010 in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (Ia) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof employable as component C),

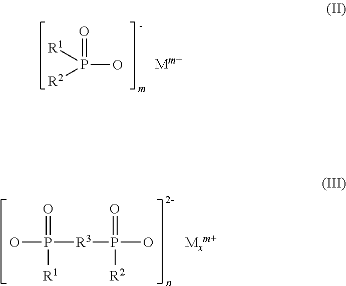

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M represents aluminum, zinc or titanium,
   m represents an integer from 1 to 4,
   n represents an integer from 1 to 3,
   x represents 1 and 2,
wherein n, x and m in formula (III) can simultaneously assume only integers such that the diphosphinic acid salt of formula (III) is uncharged as a whole,
and
3 to 300 parts by mass, preferably 5 to 200 parts by mass, particularly preferably 10 to 120 parts by mass, especially preferably 15 to 90 parts by mass, of at least one glass-based filler and/or reinforcer employable as component D), with the proviso that component B) is employed in lower mass fractions than component C).

The present invention particularly preferably relates to the use of
B) aluminum methylphosphonate of formula (Ia)

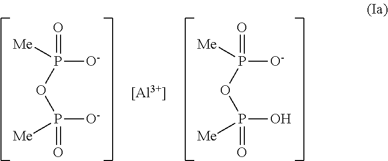

to achieve a CTI A of 600 according to IEC 60112—in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (Ia) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof employable as component C),

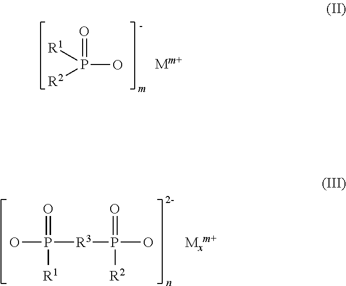

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M represents aluminum, zinc or titanium,
   m represents an integer from 1 to 4,
   n represents an integer from 1 to 3,
   x represents 1 and 2,
wherein n, x and m in formula (III) can simultaneously assume only integers such that the diphosphinic acid salt of formula (III) is uncharged as a whole,
and
3 to 300 parts by mass, preferably 5 to 200 parts by mass, particularly preferably 10 to 120 parts by mass, especially preferably 15 to 90 parts by mass, of glass fibers employable as component D), with the proviso that component B) is employed in lower mass fractions than component C).

The present invention particularly preferably relates to the use of
B) aluminum methylphosphonate of formula (Ia)

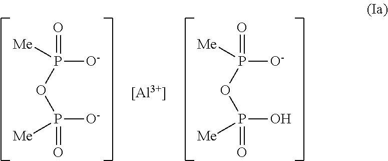

to achieve a CTI A of 600 according to IEC 60112-2010 in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (Ia) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
5 to 120 parts by mass, preferably 7 to 80 parts by mass, particularly preferably 8 to 60 parts by mass, especially preferably 10 to 50 parts by mass, of aluminum tris(diethylphosphinate) as component C)
and
3 to 300 parts by mass, preferably 5 to 200 parts by mass, particularly preferably 10 to 120 parts by mass, especially preferably 15 to 90 parts by mass, of at least one glass-based filler and/or reinforcer employable as component D), with the proviso that component B) is employed in lower mass fractions than component C).

The present invention particularly preferably relates to the use of
B) aluminum methylphosphonate of formula (Ia)

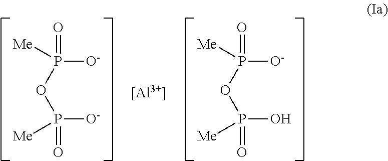

to achieve a CTI A of 600 according to IEC 60112-2010 in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (Ia) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
5 to 120 parts by mass, preferably 7 to 80 parts by mass, particularly preferably 8 to 60 parts by mass, especially preferably 10 to 50 parts by mass, of aluminum tris(diethylphosphinate) as component C)
and
3 to 300 parts by mass, preferably 5 to 200 parts by mass, particularly preferably 10 to 120 parts by mass, especially preferably 15 to 90 parts by mass, of glass fibers employable as component D), with the proviso that component B) is employed in lower mass fractions than component C).

The present invention preferably relates to the use of
B) aluminum salts of general formula (I)

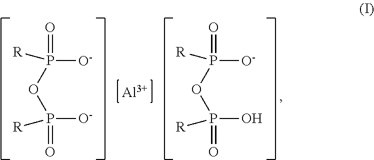

wherein R represents C₁-C₁₂-alkyl, preferably methyl, ethyl, isopropyl or isobutyl, tert-butyl or n-butyl, particularly preferably ethyl or methyl, very particularly preferably methyl, to achieve a CTI A of 600 according to IEC 60112-2010 and a laser transmittance determinable according to DVS guideline 2243 (January 2014) of at least 8% at wall thicknesses of 1.5 mm in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (I) are employed per 100 parts by mass of polyalkylene terephthalate or polycycloalkylene terephthalate, in particular polybutylene terephthalate, polyethylene terephthalate or poly-1,4-cyclohexanedimethanol terephthalate, employable as component A).

The present invention particularly preferably relates to the use of
B) aluminum methylphosphonate of formula (Ia)

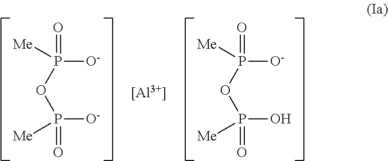

to achieve a CTI A of 600 according to IEC 60112-2010 and a laser transmittance determinable according to DVS guideline 2243 (January 2014) of at least 8% at wall thicknesses of 1.5 mm in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (Ia) are employed per 100 parts by mass of polyalkylene terephthalate or polycycloalkylene terephthalate, in particular polybutylene terephthalate, polyethylene terephthalate or poly-1,4-cyclohexanedimethanol terephthalate, employable as component A).

The present invention preferably relates to the use of
B) aluminum salts of general formula (I)

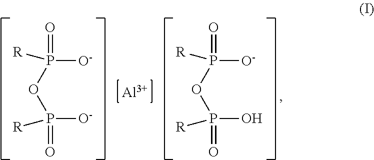

wherein R represents C₁-C₁₂-alkyl, preferably methyl, ethyl, isopropyl or isobutyl, tert-butyl or n-butyl, particularly preferably ethyl or methyl, very particularly preferably methyl, to achieve a CTI A of 600 according to IEC 60112-2010 and a laser transmittance determinable according to DVS guideline 2243 (January 2014) of at least 8% at wall thicknesses of 1.5 mm in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (I) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
and
5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof employable as component C),

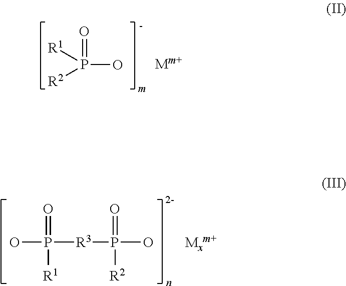

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M represents aluminum, zinc or titanium,
   m represents an integer from 1 to 4,
n represents an integer from 1 to 3,
x represents 1 and 2,
wherein n, x and m in formula (III) can simultaneously assume only integers such that the diphosphinic acid salt of formula (III) is uncharged as a whole, with the proviso that component B) is employed in lower mass fractions than component C).

The present invention particularly preferably relates to the use of
B) aluminum methylphosphonate of formula (Ia)

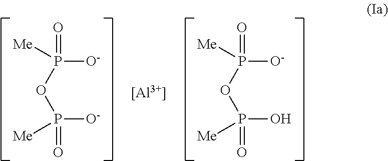

to achieve a CTI A of 600 according to IEC 60112-2010 and a laser transmittance determinable according to DVS guideline 2243 (January 2014) of at least 8% at wall thicknesses of 1.5 mm in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (Ia) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
and
5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof employable as component C),

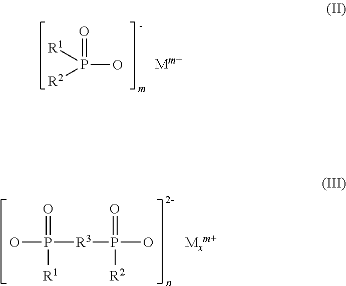

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M represents aluminum, zinc or titanium,
   m represents an integer from 1 to 4,
n represents an integer from 1 to 3,
x represents 1 and 2,
wherein n, x and m in formula (III) can simultaneously assume only integers such that the diphosphinic acid salt of formula (III) is uncharged as a whole, with the proviso that component B) is employed in lower mass fractions than component C).

The present invention preferably relates to the use of
B) aluminum salts of general formula (I)

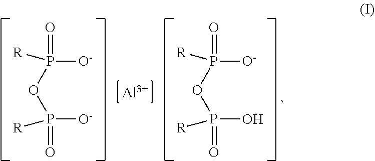

wherein R represents C₁-C₁₂-alkyl, preferably methyl, ethyl, isopropyl or isobutyl, tert-butyl or n-butyl, particularly preferably ethyl or methyl, very particularly preferably methyl, to achieve a CTI A of 600 according to IEC 60112-2010 and a laser transmittance determinable according to DVS guideline 2243 (January 2014) of at least 8% at wall thicknesses of 1.5 mm in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (I) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof employable as component C),

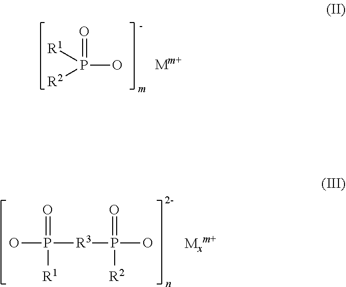

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M represents aluminum, zinc or titanium,
   m represents an integer from 1 to 4,
n represents an integer from 1 to 3,
x represents 1 and 2,
wherein n, x and m in formula (III) can simultaneously assume only integers such that the diphosphinic acid salt of formula (III) is uncharged as a whole,
and
3 to 300 parts by mass, preferably 5 to 200 parts by mass, particularly preferably 10 to 120 parts by mass, especially preferably 15 to 90 parts by mass, of at least one glass-based filler and/or reinforcer employable as component D), with the proviso that component B) is employed in lower mass fractions than component C).

The present invention particularly preferably relates to the use of
B) aluminum methylphosphonate of formula (Ia)

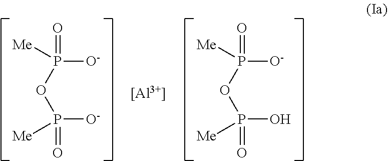

to achieve a CTI A of 600 according to IEC 60112-2010 and a laser transmittance determinable according to DVS guideline 2243 (January 2014) of at least 8% at wall thicknesses of 1.5 mm in or for polyester-based products, wherein 1 to 80 parts by mass, preferably 2 to 60 parts by mass, particularly preferably 3 to 30 parts by mass, especially preferably 5 to 20 parts by mass, of aluminum salt of formula (Ia) are employed per
100 parts by mass of polyalkylene terephthalate or polycycloalkylene terephthalate, in particular polybutylene terephthalate, polyethylene terephthalate or poly-1,4-cyclohexanedimethanol terephthalate, employable as component A),
5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof employable as component C),

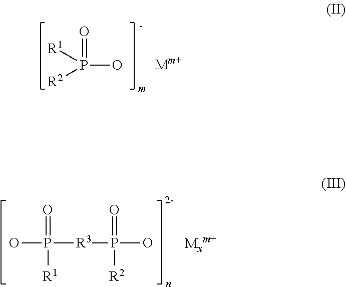

wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
   M represents aluminum, zinc or titanium,
   m represents an integer from 1 to 4,
n represents an integer from 1 to 3,
x represents 1 and 2,
wherein n, x and m in formula (III) can simultaneously assume only integers such that the diphosphinic acid salt of formula (III) is uncharged as a whole,
and
3 to 300 parts by mass, preferably 5 to 200 parts by mass, particularly preferably 10 to 120 parts by mass, especially preferably 15 to 90 parts by mass, of at least one glass-based filler and/or reinforcer employable as component D), with the proviso that component B) is employed in lower mass fractions than component C).

The present invention finally provides for the use of the compositions according to the invention for producing products, preferably products for electromobility, for household appliances and in the electronics and electricals sector.

### Further Preferred Compositions

The present invention provides compositions comprising
A) per 100 parts by mass of polybutylene terephthalate, polyethylene terephthalate or poly-1,4-cyclohexanedimethanol terephthalate,
B) 1 to 80 parts by mass, preferably 2 to 60 parts by mass, particularly preferably 3 to 30 parts by mass, especially preferably 5 to 20 parts by mass of aluminum methylphosphonate of formula (Ia)

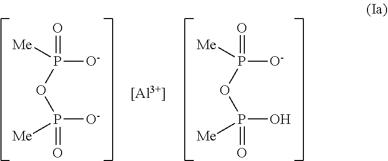

C) 5 to 120 parts by mass, preferably 7 to 80 parts by mass, particularly preferably 8 to 60 parts by mass, of aluminum tris(diethylphosphinate) and
D) 3 to 300 parts by mass, preferably 5 to 200 parts by mass, particularly preferably 10 to 120 parts by mass, especially preferably 15 to 90 parts by mass, of glass fibers
   with the proviso that component B) is present in lower mass fractions than component C).

Very particular preference is given to compositions employing polybutylene terephthalate as component A), aluminum methylphosphonate of formula (Ia)

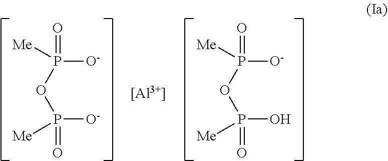

as component B), aluminum tris(diethylphosphinate) as component C) and glass fibers as component D).

### Further Preferred Processes

The present invention further provides a process for producing products, preferably products for electromobility, for household appliances and in the electronics and electricals sector, comprising mixing or blending component A) 100 parts by mass of polybutylene terephthalate, polyethylene terephthalate or poly-1,4-cyclohexanedimethanol terephthalate with
B) 1 to 80 parts by mass, preferably 2 to 60 parts by mass, particularly preferably 3 to 30 parts by mass, especially preferably 5 to 20 parts by mass, of aluminum methylphosphonate of formula (Ia)

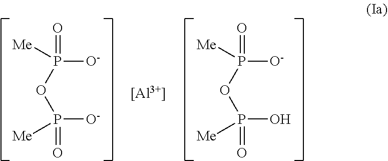

C) 5 to 120 parts by mass, preferably 7 to 80 parts by mass, particularly preferably 8 to 60 parts by mass, of aluminum tris(diethylphosphinate) and
D) 3 to 300 parts by mass, preferably 5 to 200 parts by mass, particularly preferably 10 to 120 parts by mass, especially preferably 15 to 90 parts by mass, of glass fibers
and optionally with further additives in at least one mixing apparatus and finally processing the resulting mixture by injection molding with the proviso that component B) is employed in lower mass fractions than component C).

Very particular preference is given to processes employing polybutylene terephthalate as component A), aluminum methylphosphonate of formula (Ia)

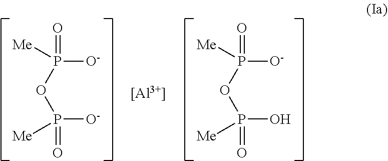

as component B), aluminum tris(diethylphosphinate) as component C) and glass fibers as component D).

### EXAMPLES

To demonstrate the improvements in properties described according to the invention corresponding polyalkylene terephthalate- or polycycloalkylene terephthalate-based polymer compositions were initially manufactured by compounding. To this end the individual components according to Tab. I were mixed in a twin-screw extruder (ZSK 25 Compounder from Coperion Werner & Pfleiderer (Stuttgart, Germany)) at temperatures in the range from 260° C. to 290° C., extruded, cooled until pelletizable and pelletized. After drying, generally 2 hours at 120° C. in a vacuum drying cabinet, the pellet material was processed by injection molding at temperatures in the range from 260° C. to 290° C. to afford standard test specimens for the respective tests using an Arburg 320-210-500 injection molding machine.

Production of the aluminum methylphosphonate of formula (Ia) employed as component B) in the examples and comparative examples was carried out according to example 1 of WO 2021/076169 A1.

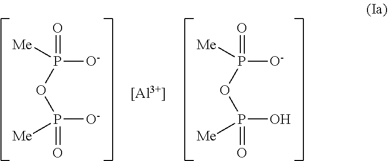

### Tracking Resistance

The tracking resistance (“comparative tracking index”) was determined on the basis of IEC 60112-2010 using test specimens having dimensions of 60 mm×40 mm×4 mm at a test voltage of 600V with test solution A.

In a departure from the standard, testing was carried out not with 50 droplets in each case on 5 test specimens (250 droplets) but rather, and even more demandingly, with 100 droplets in each case on 3 test specimens (altogether 300 droplets) and the average number of droplets until failure of the material due to a tracking current of >0.5 A or ignition with a subsequent continuous flame on the test specimen was determined.

### Laser Transparency

The laser transparency of the samples investigated in the context of the present invention was measured at a laser wavelength of 980 nm in accordance with DVS Guideline 2243 (January 2014) “Laserstrahlschweißen thermoplastischer Kunststoffe” using test specimens having dimensions of 125 mm×13 mm×1.5 mm in the near infrared (NIR) range with the transmittance measuring instrument LPKF TMG3 from LPKF Laser & Electronics AG, Garbsen, Germany which had previously been calibrated with a measurement standard produced according to DIN EN ISO/IEC 17025, see: LPKF AG 101016-DE: “Einfache Transmissionsmessung für Kunststoffe LPKF TMG3”.

### Flame Retardancy

The flame retardancy of the test specimens having dimensions of 125 mm·13 mm·0.75 mm was determined according to the method UL94V (Underwriters Laboratories Inc. Standard of Safety, “Test for Flammability of Plastic Materials for Parts in Devices and Appliances”, p. 14-18 Northbrook 1998).

### IZOD Impact Resistance

The IZOD impact resistance was determined according to ISO180-A on test specimens having dimensions of 80 mm×10 mm×4 mm.

The flexural strength and the outer fiber strain were obtained from flexural tests according to ISO178 on test specimens having dimensions of 80 mm×10 mm×4 mm.

### Starting Materials:

Component A/1): Linear polybutylene terephthalate (mixture of Pocan® B 1300 having an intrinsic viscosity of 93 cm³/g (in each case measured in phenol: 1,2-dichlorobenzene=1:1 at 25° C.) in a ratio of 3:2. Both Pocan® types are commercially available products of Lanxess Deutschland GmbH, Cologne, Germany.
Component B/1): Aluminum methylphosphonate of formula (Ia) produced according to WO 2021/076169 A1, example 1
Component C/1): Aluminum tris(diethylphosphinate), [CAS No. 225789-38-8](Exolit® OP1240 from Clariant SE, Muttenz, Switzerland)
Component D/1): Chopped glass fiber CS 7967D from Lanxess Deutschland GmbH, Cologne, Germany [average fiber diameter 10 μm, average fiber length 4.5 mm, E glass (DIN 1259), silane-sized]
Component E): As further additives of component E) the examples employed the following components customary for use in flame-retarded thermoplastic polyesters:
   Antidrip additive: Polytetrafluoroethylene, [CAS No. 9002-84-0](Dyneon® PA 5932 from Dyneon GmbH & Co KG, Neuss, Germany)
   Heat stabilizer: Tetrakis(2,4-di-tert-butylphenyl)-1,1-biphenyl-4,4′-diylbisphosphonite [CAS No. 38613-77-3](Hostanox® P-EPQ from Clariant International Ltd., Muttenz, Switzerland)
   Demolding agent: Pentaerythritol tetrastearate (PETS) [CAS No. 115-83-3](Loxiol® VPG 861, Cognis Deutschland GmbH, Dusseldorf, Germany)
   The employed further additives (component E) in each case coincide in terms of type and amount for corresponding comparative examples and examples, namely with a total of 1.0 parts by mass.
Component X/1): Melamine cyanurate, (Melapur® MC25, BASF SE, Ludwigshafen, Germany)

TABLE I

| | | Ex. 1 | Comp. 1 | Comp. 2 |
|---|---|---|---|---|
| Component A/1 | Mass fraction | 100 | 100 | 100 |
| Component B/1 | Mass fraction | 9.5 | 0.0 | 0.0 |
| Component C/1 | Mass fraction | 27.6 | 27.6 | 37.1 |
| Component D/1 | Mass fraction | 34.5 | 34.5 | 34.5 |
| Component E | Mass fraction | 1.0 | 1.0 | 1.0 |
| Component X/1 | Mass fraction | 0.0 | 9.5 | 0.0 |
| UL94 (0.75 mm) | [Class] | V0 | V0 | — |
| CTI A at 600 V | [number of | 100 | >50, <100 | <50 |
| | droplets, average] | | | |
| IZOD | [kJ/m²] | 35 | <30 | — |
| Flexural strength | [MPa] | 149 | 143 | — |
| Outer fiber strain | [%] | 2.8 | <2.5 | — |
| LPKF laser | [%] | 9.7 | <8 | — |
| transmission | | | | |

Components in Tab. I reported in parts by mass based on 100 parts by mass of component A1

Table I shows that only the inventive example 1 both exhibits a UL94 classification V0 at 0.75 mm and achieves a CTI A at 600V under much more demanding conditions compared to the standard with 100 droplets in each case on 3 test specimens (altogether 300 droplets) while moreover also exhibiting a laser transmittance markedly above 8% for a test specimen of 1.5 mm in thickness.

Compared to a formulation comprising a nitrogen-containing flame retardant (comp. 1) example 1 also exhibits a better mechanical performance as is apparent for example from higher values for IZOD impact strength and a better outer fiber strain.

1. A composition comprising
A) per 100 parts by mass of polyalkylene terephthalate or polycycloalkylene terephthalate,
B) 1 to 80 parts by mass, preferably 2 to 60 parts by mass, particularly preferably 3 to 30 parts by mass, especially preferably 5 to 20 parts by mass, of at least one aluminum salt of general formula (I) 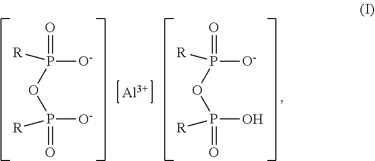
wherein R represents C₁-C₁₂-alkyl, preferably methyl, ethyl, isopropyl or isobutyl, tert-butyl or n-butyl, particularly preferably ethyl or methyl, very particularly preferably methyl,
C) 5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof, 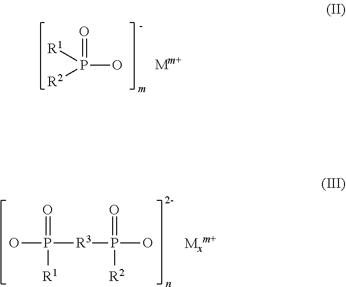
wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
M represents aluminum, zinc or titanium,
m represents an integer from 1 to 4,
n represents an integer from 1 to 3,
x represents 1 and 2,
wherein n, x and m in formula (III) can simultaneously assume only integers such that the diphosphinic acid salt of formula (III) is uncharged as a whole and
D) 3 to 300 parts by mass, preferably 5 to 200 parts by mass, particularly preferably 10 to 120 parts by mass, especially preferably 15 to 90 parts by mass, of at least one glass-based filler and/or reinforcer
with the proviso that component B) is present in lower mass fractions than component C).

2. The composition as claimed in claim 1, characterized in that it employs polybutylene terephthalate, polyethylene terephthalate or poly-1,4-cyclohexanedimethanol terephthalate as component A).

3. The composition as claimed in claim 1, characterized in that it employs aluminum tris(diethylphosphinate) as component C).

4. The composition as claimed in claim 1, characterized in that it employs glass fibers as component D).

5. The composition as claimed in claim 1, characterized in that it employs polybutylene terephthalate as component A), aluminum methylphosphonate of formula (Ia) 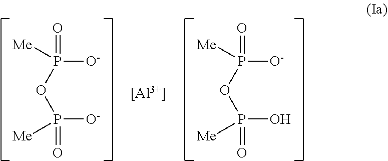
as component B), aluminum tris(diethylphosphinate) as component C) and glass fibers as component D).

6. A product, preferably a product for electromobility, for household appliances and in the electronics and electricals sector, based on the compositions as claimed in claim 1.

7. A process for producing products, preferably products for electromobility, for household appliances and in the electronics and electricals sector, comprising mixing or blending
component A) 100 parts by mass of polyalkylene terephthalate or polycycloalkene terephthalate with
B) 1 to 80 parts by mass, preferably 2 to 60 parts by mass, particularly preferably 3 to 30 parts by mass, especially preferably 5 to 20 parts by mass, of at least one aluminum salt of general formula (I) 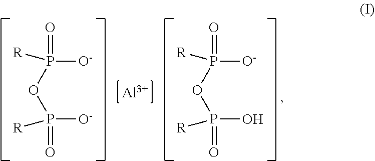
wherein R represents C₁-C₁₂-alkyl, preferably methyl, ethyl, isopropyl or isobutyl, tert-butyl or n-butyl, particularly preferably ethyl or methyl, very particularly preferably methyl,
C) 5 to 120 parts by mass, preferably 7 to 80 parts by mass, particularly preferably 8 to 60 parts by mass, especially preferably 10 to 50 parts by mass, of at least one organic phosphinic acid salt of formula (II) and/or at least one diphosphinic acid salt of formula (III) and/or of polymers thereof, 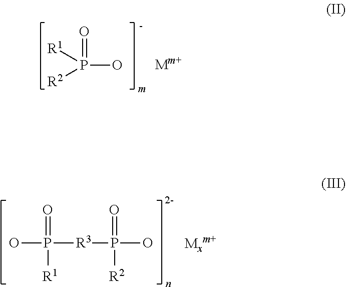
wherein
R¹, R² are identical or different and represent linear or branched C₁-C₆-alkyl, and/or represent C₆-C₁₄-aryl,
R³ represents linear or branched C₁-C₁₀-alkylene, C₆-C₁₀-arylene or C₁-C₆-alkyl-C₆-C₁₀-arylene or C₆-C₁₀-aryl-C₁-C₆-alkylene,
M represents aluminum, zinc or titanium,
m represents an integer from 1 to 4,
n represents an integer from 1 to 3,
x represents 1 and 2,
wherein n, x and m in formula (III) can simultaneously assume only integers such that the diphosphinic acid salt of formula (III) is uncharged as a whole and
D) 3 to 300 parts by mass, preferably 5 to 200 parts by mass, particularly preferably 10 to 120 parts by mass, especially preferably 15 to 90 parts by mass, of at least one glass-based filler and/or reinforcer
and optionally with further additives in at least one mixing apparatus and finally processing the resulting mixture by injection molding with the proviso that component B) is employed in lower mass fractions than component C).

8. The process as claimed in claim 7, characterized in that it employs polybutylene terephthalate, polyethylene terephthalate or poly-1,4-cyclohexanedimethanol terephthalate as component A).

9. The process as claimed in claim 7, characterized in that it employs aluminum tris(diethylphosphinate) as component C).

10. The process as claimed in claim 7, characterized in that it employs glass fibers as component D).

11. The process as claimed in claim 7, characterized in that it employs polybutylene terephthalate as component A), aluminum methylphosphonate of formula (Ia) 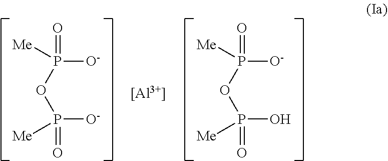
as component B), aluminum tris(diethylphosphinate) as component C) and glass fibers as component D).

12. The use of the compositions as claimed in claim 1 for producing products, preferably products for electromobility, for household appliances and in the electronics and electricals sector.
